(19) United States
(12) Patent Application Publication
(10) Pub. No.: US 2022/0293011 A1
(43) Pub. Date: Sep. 15, 2022

(54) TEACHING AID FOR BINARY PROGRAMMING LANGUAGE

(71) Applicant: Yung-Hsin KO, Taichung (TW)

(72) Inventor: Yung-Hsin KO, Taichung (TW)

(21) Appl. No.: 17/197,490

(22) Filed: Mar. 10, 2021

(51) Int. Cl. G09B 23/02; G09B 19/02; G09B 19/00; A63F 9/08

(52) U.S. Cl. CPC G09B 23/02; G09B 19/02; G09B 19/0053; A63F 9/0842

(57) ABSTRACT

A teaching aid for binary programming language contains: a Rubik's cube including six surfaces. Each side has fourth corner pieces, four side pieces, and a center piece which are rotatable. Each of the four side pieces is defined among any two adjacent corner pieces and the center piece, and the center piece is defined among the four corner pieces and the four side pieces. The center piece has a calculation sign, and each of the fourth corner pieces and the four side pieces has a binary number.

### FIELD OF THE INVENTION

The present invention relates to a teaching aid for binary programming language which enhances learning and teaching interests of the binary programming language.

### BACKGROUND OF THE INVENTION

There are not enough auxiliary teaching aids for basic calculations of binary programming languages in the market. Conventionally, a teaching method of binary programming languages must be written on paper or blackboard. However, the functions of the conventional methods are limited and can only provide children with counts. Is too boring to arouse learning motivation

The present invention has arisen to mitigate and/or obviate the afore-described disadvantages.

### SUMMARY OF THE INVENTION

The primary objective of the present invention is to provide a teaching aid for binary programming language which enhances learning and teaching interests of the binary programming language.

Further objective of the present invention is to provide a teaching aid for binary programming language which facilitates easy understanding and learning of the binary programming language

To obtain the above mentioned objective, a teaching aid for binary programming language provided by the present invention contains: a Rubik's cube including six surfaces.

Each side has fourth corner pieces, four side pieces, and a center piece which are rotatable.

Each of the four side pieces is defined among any two adjacent corner pieces and the center piece, and the center piece is defined among the four corner pieces and the four side pieces.

The center piece has a calculation sign, and each of the fourth corner pieces and the four side pieces has a binary number.

### BRIEF DESCRIPTION OF THE DRAWINGS

FIG. 1 is a perspective view showing the assembly of a teaching aid for binary programming language according to a preferred embodiment of the present invention.

FIG. 2 is another perspective view showing the assembly of the teaching aid for binary programming language according to the preferred embodiment of the present invention.

### DETAILED DESCRIPTION OF THE PREFERRED EMBODIMENTS

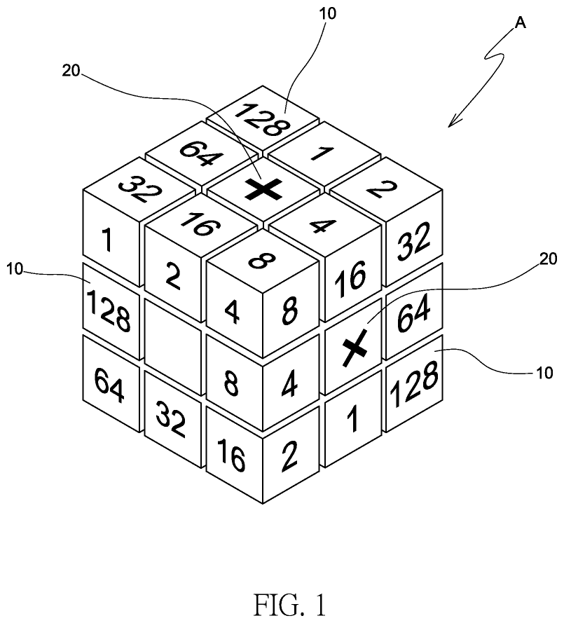

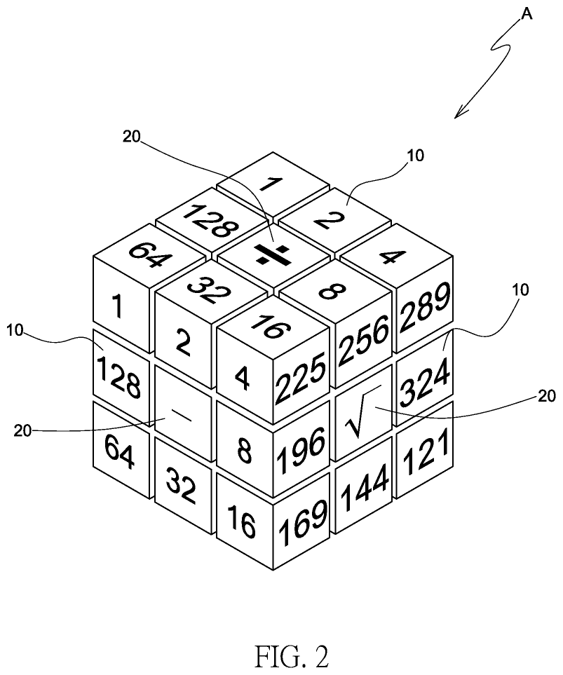

With reference to FIGS. 1-2, a teaching aid for binary programming language according to a preferred embodiment of the present invention comprises: a Rubik's cube A including six surfaces, and each side has fourth corner pieces, four side pieces, and a center piece which are rotatable, each of the four side pieces is defined among any two adjacent corner pieces and the center piece, and the center piece is defined among the four corner pieces and the four side pieces, wherein the center piece has a calculation sign 20, and each of the fourth corner pieces and the four side pieces has a binary number 10.

Each binary number 10 is any one of 2 to a zero power of 0=1, 2 to a 1^{st} power=2, 2 to a 2^{nd} power=4, 2 to a 3^{rd} power=8, 2 to a 4^{th} power=16, 2 to a 5^{th} power=32, 2 to a 6^{th} power=64, and 2 to a 7^{th} power=128.

Each binary number 10 is any one of a square root of 121=11, a square root of 144=12, a square root of 169=13, a square root of 196=14, a square root of 225=15, a square root of 256=16, a square root of 289=17, and a square root of 324=18.

Thereby, each binary number 10 is configured to be rotatable to display calculation answer based on a question or a teaching instruction, and the calculation sign 20 of the center piece is applied to display calculation instruction, thus enhancing learning and teaching interests of the binary programming language.

Preferably, the teaching aid of the present invention facilitates easy understanding and learning of the binary programming language.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A teaching aid for binary programming language comprising:
a Rubik's cube including six surfaces, and each side having fourth corner pieces, four side pieces, and a center piece which are rotatable, each of the four side pieces being defined among any two adjacent corner pieces and the center piece, and the center piece being defined among the four corner pieces and the four side pieces; and
wherein the center piece has a calculation sign, and each of the fourth corner pieces and the four side pieces has a binary number.

2. The teaching aid as claimed in claim 1, wherein each binary number is any one of 2 to a zero power of 0=1, 2 to a 1^{st} power=2, 2 to a 2^{nd} power=4, 2 to a 3^{rd} power=8, 2 to a 4^{th} power=16, 2 to a 5^{th} power=32, 2 to a 6^{th} power=64, and 2 to a 7^{th} power=128.

3. The teaching aid as claimed in claim 1, wherein each binary number is any one of a square root of 121=11, a square root of 144=12, a square root of 169=13, a square root of 196=14, a square root of 225=15, a square root of 256=16, a square root of 289=17, and a square root of 324=18.
